(19) United States
(12) Patent Application Publication
(10) Pub. No.: US 2009/0070219 A1
(43) Pub. Date: Mar. 12, 2009

(54) TARGETING ADVERTISEMENTS IN A SOCIAL NETWORK

(76) Inventors: Adam D'Angelo, (US); Aditya Agarwal, (US); Kang-Xing Jin, (US); Yun-Fang Juan, (US); Levy Klots, (US); Oleksandr Moskalyuk, (US); Yishan Wong, (US)

Correspondence Address: FENWICK & WEST LLP, SILICON VALLEY CENTER, 801 CALIFORNIA STREET, MOUNTAIN VIEW, CA, 94041, US

(21) Appl. No.: 12/195,321

(22) Filed: Aug. 20, 2008

Related U.S. Application Data
(60) Provisional application No. 60/965,624, filed on Aug. 20, 2007.

(51) Int. Cl. G06Q 30/00; G06Q 10/00; G06Q 40/00; G06Q 90/00

(52) U.S. Cl. 705/14; 705/1; 705/37

(57) ABSTRACT

A social networking website logs information about actions taken by members of the website. For a particular member of the website, the website presents targeted ads based on actions by the member and one or more characteristics of the member. The social networking website maintains a profile associated with the member which describes characteristics of the member, such as age, geographic location, employment, educational history and interests. The social networking website compares the member profile to targeting criteria for a plurality of advertising requests and determines the advertising requests that match the member profile and generate the most revenue for the social networking website. When presenting a member with an ad, the website may optimize advertising revenue by selecting an ad from the received ads that will maximize the expected value of the ad.

### CROSS REFERENCE TO RELATED APPLICATIONS

This application claims the benefit of U.S. Provisional Application No. 60/965,624, filed Aug. 20, 2007, which is incorporated by reference in its entirety.

### BACKGROUND

This invention relates generally to social networking websites in which users can form connections with each other, and in particular to targeting advertisements and other messages to users of a social networking website.

Social networks, or social utilities that track and enable connections between members (including people, businesses, and other entities), have become prevalent in recent years. Social networking websites allow members to communicate information more efficiently. A member has a profile that describes the member's interests, geographic location, age, interests or hobbies or other information describing the member. For example, a member may post contact information, background information, job information, hobbies, and/or other member-specific data to a profile associated with the member on a social networking website. Other members can then review the posted data by browsing member profiles or searching for profiles including specific data. The social networking websites also allow members to associate themselves with other members, thus creating a web of connections among the members of the social networking website. These connections among the members can be exploited by the website to offer more relevant information to each member in view of the members' own stated interests in their connections.

Social networking websites typically incorporate a system for connecting members to content that is most likely to be relevant to each member. For example, members may be grouped according to one or more common attributes in their profiles, such as geographic location, employer, job type, age, music preferences, interests, or other attributes.

Conventionally, advertisers pay various publications, websites and other content distributors to display advertisements. On the Internet, advertisements, or “ads,” provide a source of revenue for websites displaying ads, which often receive compensation from advertisers based on how many users view or click on a displayed advertisement. Hence, websites can increase revenue by increasing the number of users who click on displayed ads. As users are more likely to click on ads relevant to their interests or characteristics, displaying ads targeted to specific user groups increases website revenue and also increases the number of users accessing content from the advertiser. However, due to privacy concerns, access to data about specific groups of users, which can be used to target displayed advertisements, is generally limited. This limited availability of user data thus limits the ability of websites to display ads relevant to users.

### SUMMARY

To present more effective advertising to its members, a social network uses information it obtains about its members' characteristics, actions and their connections to other members of the social network. The social network allows advertisers to provide advertisements that are personalized to the individual interests or characteristics of various social network members. Data from a member profile maintained by the social network as well as data describing a member's interactions with other members and/or other content is used by an advertiser to provide ads that are relevant to the member's interests. This allows the member to be presented with ads that are generally more interesting to the user, which in turn will generally increase revenue for the social network by making it more likely that the members will access the presented ads.

In one embodiment, a social network is implements in a social networking website that collects and logs information about actions taken by members of the website. These logged actions may be actions performed by a member in connection with an object within the social networking website, actions taken by a member on another website and communicated to the social networking website, or real world actions captured and communicated to the social networking website. The logged actions in connection with the social networking website can include, for example, sending a message to another member, using a third-party application, joining a group, leaving a group, generating an event description, purchasing or reviewing a product or service using an online marketplace, requesting information from a third-party website or other modification or retrieval of data stored by the social networking website or a third-party website. The social networking website may also collect data about the members—such as age, geographic location, hobbies, education and employment—which is maintained in a member profile.

To select an advertisement for a particular user, the logged actions and possibly member profile information are compared to multiple ad requests the social networking website receives from advertisers. Each ad request may include one or more ads as well as targeting criteria for use in determining which users can be presented the ads. In one embodiment, the targeting criteria identify one or more actions taken by a user, within the social networking website, on another website, or possibly in the real world. The targeting criteria may also specify characteristics of a member profile for further targeting the ads. When selecting an ad to present to a particular user, the social networking website compares the ad requests to information for the member profiles and the logged actions to identify ads that have target criteria that match the user. The social networking website then displays one or more of these matching ads to the user matching. In this way, members of the social networking website are presented with ads that are generally more relevant to them, based on their interests and interaction history, thereby increasing the likelihood that the members will access the ads. In one advertising model, each advertiser may bid a certain amount of money for each instance that a member clicks on or takes some other follow-on action with respect to the ad.

The social networking website may also select which ad or ads to present to a particular member based on the expected revenue values for each of the qualified ads, in order to maximize ad revenue with respect to a given member. The expected revenue value for an ad may be a function of a member's affinity for the content of the information in the ad (which acts as a proxy for the likelihood that a member will click on the ad) and the amount of money that the social networking website will receive for that action. In some cases the expected revenue value may additionally be a function of the member's likelihood of clicking on an ad based on other ads the member has clicked on in the past.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE FIGURES

FIG. 1 is a high level block diagram of a system environment for providing targeted advertisements to members of a social networking website according to one embodiment of the invention.

FIG. 2 is a network diagram of a system environment for providing ads to members of a social networking website, in accordance with an embodiment of the invention.

FIG. 3 is a block diagram of a social networking website, in accordance with an embodiment of the invention.

FIG. 4 is a flow chart of a process for selecting ads targeted to a social network member, in accordance with an embodiment of the invention.

FIG. 5 is an event diagram of an advertising model, in accordance with an embodiment of the invention.

FIG. 6 is an example of an ad request, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DESCRIPTION

A social networking website offers its members the ability to communicate and interact with other members of the website. In use, members join the social networking website and then add connections to a number of other members to whom they desire to be connected. As used herein, the term “friend” refers to any other member to whom a member has formed a connection, association, or relationship via the website. Connections may be added explicitly by a member, for example, the member selecting a particular other member to be a friend, or automatically created by the social networking site based on common characteristics of the members (e.g., members who are alumni of the same educational institution). Connections in social networking websites are usually in both directions, but need not be, so the terms “member” and “friend” depend on the frame of reference. For example, if Bob and Joe are both members and connected to each other in the website, Bob and Joe, both members, are also each other's friends. The connection between members may be a direct connection; however, some embodiments of a social networking website allow the connection to be indirect via one or more levels of connections. Also, the term friend need not require that members actually be friends in real life, (which would generally be the case when one of the members is a business or other entity); it simply implies a connection in the social networking website.

In addition to interactions with other members, the social networking website provides members with the ability to take actions on various types of items supported by the website. These items may include groups or networks (where “networks” here refer not to physical communication networks, but rather social networks of people) to which members of the website may belong, events or calendar entries in which a member might be interested, computer-based applications that a member may use via the website, and transactions that allow members to buy or sell items via the website. These are just a few examples of the items upon which a member may act on a social networking website, and many others are possible.

As illustrated, the social networking website 100 maintains a number of objects for the different kinds of items with which a member may interact on the website 100. In one example embodiment, these objects include member profiles 105, group objects 110, event objects 115, application objects 120, and transaction objects 125 (respectively, hereinafter, groups 110, events 115, applications 120, and transactions 125). In one embodiment, an object is stored by the website 100 for each instance of its associated item. For example, a member profile 105 is stored for each member who joins the website 100, a group 110 is stored for each group defined in the website 100, and so on. The types of objects and the data stored for each is described in more detail below in connection with FIG. 3, which illustrates an embodiment of the social networking website 100.

The member of the website 100 may take specific actions on the website 100, where each action is associated with one or more objects. The types of actions that a member may perform in connection with an object is defined for each object and largely depends on the type of item represented by the object. A particular action may be associated with multiple objects. Described below are a number of examples of particular types of objects that may be defined for the social networking website 100, as well as a number of actions that can be taken for each object. These objects and the actions discussed herein are provided for illustration purposes only, and it can be appreciated that an unlimited number of variations and features can be provided on a social networking website 100.

The social networking website 100 maintains a member profile 105 for each member of the website 100. Any action that a particular member takes with respect to another member is associated with each member's profile 105. Such actions may include, for example, adding a connection to the other member, sending a message to the other member, reading a message from the other member, viewing content associated with the other member, attending an event posted by another member, among others. In addition, a number of actions described below in connection with other objects are directed at particular members, so these actions are associated with those members as well.

A group 110 may be defined for a group or network of members. For example, a member may define a group to be a fan club for a particular band. The website 100 would maintain a group 110 for that fan club, which might include information about the band, media content (e.g., songs or music videos) by the band, and discussion boards on which members of the group can comment about the band. Accordingly, member actions that are possible with respect to a group 110 might include joining the group, viewing the content, listening to songs, watching videos, and posting a message on the discussion board.

Similarly, an event 115 may be defined for a particular event, such as a birthday party. A member may create the event 115 by defining information about the event such as the time and place and a list of invitees. Other members may accept the invitation, comment about the event, post their own content (e.g., pictures from the event), and perform any other actions enabled by the website 100 for the event 115. Accordingly, the creator of the event 115 as well as the invitees for the event may perform various actions that are associated with that 115.

The social networking website may also enable members to add applications to their profiles. These applications provide enhanced content and interactivity within the social networking website 100, which maintains an application object 120 for each application hosted in the system. The applications may be provided by the website operator and/or by third party developers. An example application is an enhanced messaging service, in which members can send virtual objects (such as a “gift” or “flowers”) and an optional message to another member. The use of any functionality offered by the application may thus constitute an action by the member in connection with the application 120. In addition, continuing the example from above, the receipt of the virtual gift or message may also be considered an action in connection with the application 120. It can therefore be appreciated that actions may be passive and need not require active participation by a member.

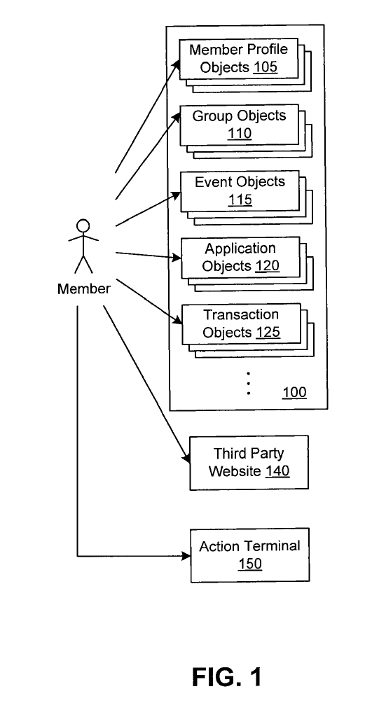

Another type of object shown in the example of FIG. 1 is a transaction 125. A transaction object enables members to make transactions, such as buying, selling, renting, trading, or exchanging with other members. For example, a member may post a classified ad on the social networking website 100 to sell a car. The member would thus define a new transaction 125, which may include a description of the car, a picture, and an asking price. Other members can then view this information and possibly interact further with the transaction 125 by posting questions about the car and accepting the offer or making a counteroffer. Each of these interactions—view, question posting, offer, and counteroffer—are actions that are associated with the particular transaction 125.

When a member takes an action on the social networking website 100, the action is recorded in an action log 160 (shown in FIG. 3). In one embodiment, the website 100 maintains the action log 160 as a database of entries. When an action is taken on the website 100, therefore, the website 100 adds an entry for that action to the log 160. In one embodiment, an entry comprises some or all of the following information:

Time: a timestamp of when the action occurred.

Member: an identifier for the member who performed the action.

Target: an identifier for the member to whom the action was directed.

Action Type: an identifier for the type of action performed.

Object: an identifier for an object acted on by the action.

Content: content associated with the action.

It can be appreciated that many types of actions that are possible in the website 100 need not require all of this information. For example, if a member changes a picture associated with the member's profile, the action may be logged with just the member's identifier, an action type defining a picture change, and the picture or a link thereto as the content.

In one embodiment, the social networking website 100 also logs actions that a member takes on a third party website 140. The social networking website 100 may learn of the member's actions on the third party website 140 via any of a number of methods. For example, the third party website 140 may send a message to the social networking website 100 when a particular action by a member occurs on the third party website 140. In one example, if the third party website 140 is a commercial website on which members may purchase items, the third party website 140 may inform the social networking website 100 when a member of the social networking website 100 buys an item on the third party website 140.

In another embodiment, the social networking website 100 logs actions taken by its members in the real world. These actions may be recorded by an action terminal 150, which observes qualifying actions and then communicates that action to the social networking website 100. The communication may be via email, SMS, or any other appropriate means, where the communicated message includes sufficient information for the social networking website 100 to populate the action log 160 with an entry describing the action. The action terminal 150 may comprise any suitable devices or systems for the particular type of action to be tracked.

In one embodiment, the action to be tracked is a credit card transaction, where a member of the social networking website 100 may optionally opt in by registering a credit card. When the registered credit card is used in a qualifying way (e.g., a purchase made at a point of sale), the credit card company (or clearinghouse) sends a message to the social networking website 100. In this scenario, a computing system at the credit card company or clearinghouse serves as a action terminal 150. The message may contain information about the credit card transaction, such the item purchased, the date, and location of the purchase. The social networking system thus tracks real-world actions such as this purchase in the action log 160.

Another example illustrating real-world actions that may be tracked involves the member's location. A member may configure a cellular phone having location technology (e.g., GPS) to communicate the member's location to the social networking website 100. This may be accomplished, for example, by downloading an application to the cellular phone, where the application polls the location unit in the phone and sends a message containing the member's location to the social networking website 100. This may be performed periodically or upon certain triggering events associated with locations. For example, a triggering event can include the member being within to a specific city, or at particular destination such as a restaurant, business, or venue. In this application, the cellular phone (or other GPS-enabled device) serves as the action terminal 150.

Another example illustrating real-world actions that may be tracked involves what program material the member is accessing on a television system. A television and/or set-top receiver may act as an action terminal 150 and transmit a message indicating that a member is viewing (or recording) a particular program on a particular channel at a particular time. Again, these examples are presented to illustrate some of the types of devices and actions that may be captured as actions by a member and communicated to the social networking website 100. A limitless variety of other applications may be implemented to capture real-world actions associated with a particular member and send that information to the social networking website 100.

After an amount of time, the action log 160 will become populated with a number of entries that describe actions taken by the members of the social networking website 100. The action log 160 thus contains a very rich set of data about the actions of the members, and can be analyzed and filtered to identify trends and relationships in the actions of the members, as well as affinities between the members and various objects. This action log can, in some cases, be filtered to include only actions that are likely to be interesting to other members.

### Website Architecture

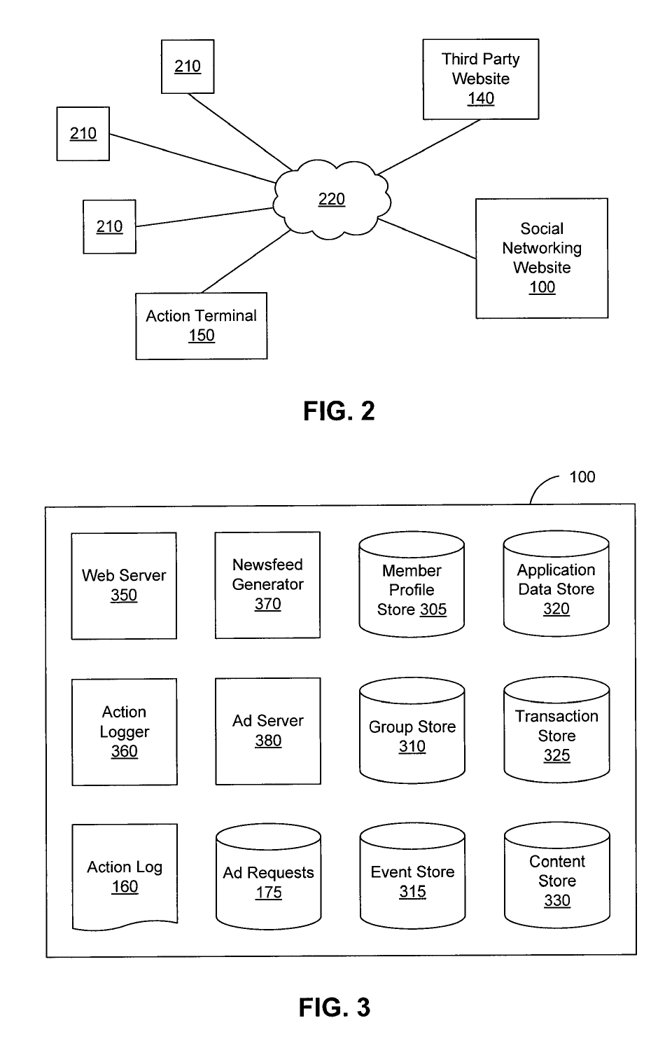

FIG. 2 is a high level block diagram illustrating a system environment suitable for operation of a social networking website 100. The system environment comprises one or more client devices 210, one or more third-party websites 140, a social networking website 100, and a network 220. In alternative configurations, different and/or additional modules can be included in the system.

The client devices 210 comprise one or more computing devices that can receive member input and can transmit and receive data via the network 220. For example, the client devices 210 may be desktop computers, laptop computers, smart phones, personal digital assistants (PDAs), or any other device including computing functionality and data communication capabilities. The client devices 220 are configured to communicate via network 220, which may comprise any combination of local area and/or wide area networks, using both wired and wireless communication systems. As described above, the third party website 140 and the action terminal 150 are coupled to the network 220 for communicating messages to the social networking website 100 about the members' actions off the website 100.

The social networking website 100 comprises a computing system that allows members to communicate or otherwise interact with each other and access content as described herein. The social networking website 100 stores member profiles that describe the members of a social network, including biographic, demographic, and other types of descriptive information, such as work experience, educational history, hobbies or preferences, location, and the like. The website 100 further stores data describing one or more relationships between different members. The relationship information may indicate members who have similar or common work experience, group memberships, hobbies, or educational history. Additionally, the social networking website 100 includes member-defined relationships between different members, allowing members to specify their relationships with other members. For example, these member defined relationships allows members to generate relationships with other members that parallel the members' real-life relationships, such as friends, co-workers, partners, and so forth. Members may select from predefined types of relationships, or define their own relationship types as needed.

FIG. 3 is an example block diagram of a social networking website 100. The social networking website 100 includes a web server 350, an action logger 360, an action log 160, a newsfeed generator 370, an ad server 380, a database of ad requests 175, a member profile store 305, a group store 310, an event store 315, an application data store 320, a transaction store 325, and a content store 330. In other embodiments, the social networking website 100 may include additional, fewer, or different modules for various applications.

The web server 350 links the social networking website 100 via the network 220 to one or more client devices 210, as well as to one or more third party websites 140. The web server 350 may include a mail server or other messaging functionality for receiving and routing messages between the social networking website 100 and the client devices 210 or third party websites 140. The messages can be instant messages, queued messages (e.g., email), text and SMS messages, or any other suitable messaging technique.

The action logger 360 is capable of receiving communications from the web server 350 about member actions on and/or off the social networking website 100. The received actions can occur within the social networking website 100 as well on other websites, via an application programming interface exposed by the social networking website 100. In one embodiment, the social networking website 130 maintains the action log as a database of entries. When an action is taken on and/or off the social networking website 100, an entry for that action is generated and stored by the action logger 360. Examples of user actions within the social networking website 100 include sending a message to a friend, using a third-party application, joining a group, leaving a group, adding a relationship to another user, removing a relationship to another user, modifying a stored user profile, generating an event description or other modification or retrieval of data stored by the social networking website 100. Examples of user actions outside of the social networking website 100 include purchasing or reviewing a product or service using an online marketplace hosted by a third-party website 140, registering with or subscribing to a website hosted by a third-party application server 120, purchase, requesting information from the third-party website 140 similar actions performed on a third-party website 140.

The action logger 360 includes data describing the member performing the action, the time the action occurred, an identifier for the member who performed the action, an identifier for the member to whom the action was directed, an identifier for the type of action performed, an identifier for an object acted on by the action (e.g., an application), content associated with the action, where the action occurred and/or other data describing the action. It can be appreciated that many types of actions that are possible in the social networking website 100 need not require all of this information. For example, if a member changes a picture associated with the member's profile, the action may be logged with just the member's identifier, an action type defining a picture change, and the picture or a link thereto as the content. The action logger 360 can communicate with the member profile store 305, event store 315 and/or the group store 310 allowing events, users and/or groups to be associated with an action. The action logger 360 can organize the stored action data according to an action identifier which uniquely identifies each stored action.

The action logger 360 can store actions based on when the action occurred. In one embodiment, a single action logger 260 stores actions from all of the social network website 100 members and organizes the stored actions according to member identifiers or partitions the action log to allocate storage for different members. Alternatively, the social network website 100 includes multiple action loggers 360 associated with different subsets of members, such as by affiliation, group, geography, or the like.

The newsfeed generator 370 generates communications for each member about information that may be relevant to the member. These communications may take the form of stories, each story is an information message comprising one or a few lines of information about an action in the action log that is relevant to the particular member. The stories are presented to a member via one or more pages of the social networking website 100, for example in each member's home page or newsfeed page. A story is a message that summarizes, condenses, or abstracts one or more member actions from the action log 160. The generated news-feed stories can then be transmitted to one or more related members—e.g., the member's friends—allowing the member's actions to be shared with related members. The newsfeed generator 370 applies an affinity algorithm to the contents of the action log 160 and member profile store 305 to account for a member's relationships with other members or groups as specified in the member profile store 305 and/or group store 310 to select the actions from the action log 150 that are to be the basis of one or more stories for distribution to the related users. By accounting for the user relationships with other users and/or groups, the newsfeed generator 370 determines data from the action log 160 most relevant to other related users.

For example, the newsfeed generator 370 generates a message identifying a particular member (e.g., User A), the type of action and, optionally, another member, group or other entity affected by the action (e.g., “User A joined Group 1”). For various messages, the newsfeed generator 370 determines the interest of various related users to different messages associated with the given user. For example, the newsfeed generator 370 determines how recently a related user accessed data from or associated with the given user, how often a related user has accessed data from or associated with the given user, the amount of common or similar data in the profiles of the given user and the related user and/or other factors representative of user interest in a particular message. Based on the determined level of related user interest, a message is communicated to those related users with the highest interest in the information message. This process can also be applied to action logs 160, or action log 160 content, associated with members related to a specific member. For example, for a given user A, the action logs 160 of related members B, C, D, E can be processed for a selected interval, and one or more messages constructed for member A based on the actions of members B, C, D, and E. Thus, member A may receive messages such as “Users B and C are attending event X,” or “User C sent User D a gift,” or “User D is now friends with User E.”

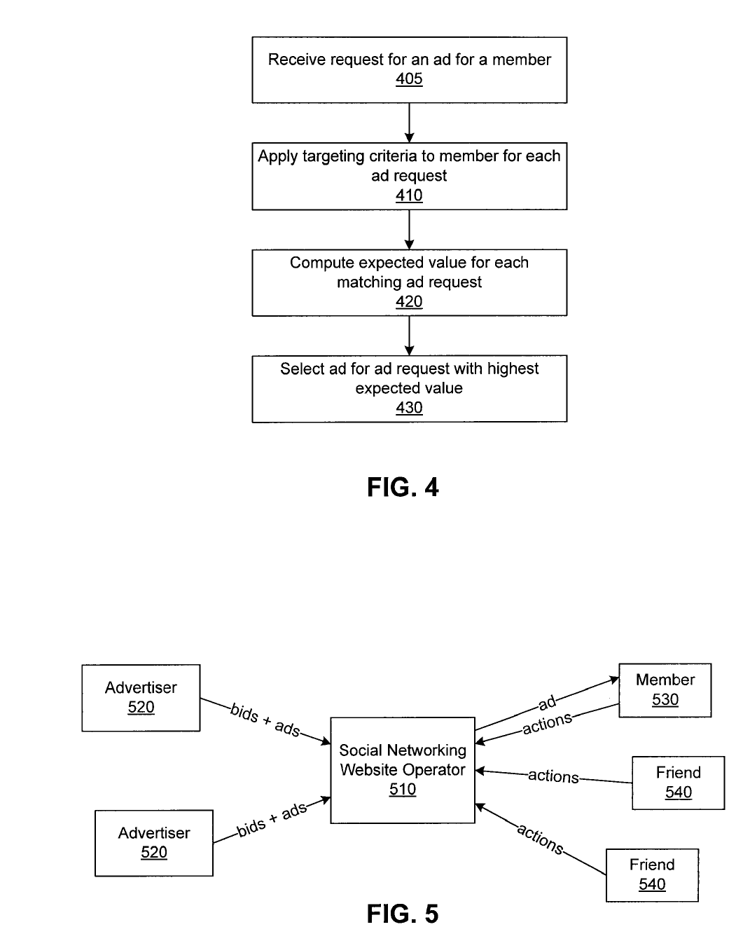

The ad server 380 is communicatively coupled to the member profile store 305, group store 310, database of ad requests 175 and to the action log 160. The ad server 380 selects an ad request from the database of ad requests 175 based on data from the member profile store 305, group store 310 and/or the action log 160 to identify an ad for presentation to the user. Hence, the ad server 380 uses data from a member profile, a member's group affiliation and prior actions to determine one or more ads that are most relevant to the characteristics and actions of a member. The operation of the ad server is further described below in conjunction with FIG. 4.

As discussed above, the social networking website 100 maintains data about a number of different types of objects with which a member may interact on the website 100. To this end, each of the member profile store 305, the group store 310, the event store 315, the application data store 320, and the transaction store 325 stores a data structure to manage the data for each instance of the corresponding type of object maintained by the website 100. The data structures comprise information fields that are suitable for the corresponding type of object. (For example, the event store 315 contains data structures that include the time and location for an event, whereas the member profile store 305 contains data structures with fields suitable for describing a member's profile.) When a new object of a particular type is created, the website 100 initializes a new data structure of the corresponding type, assigns a unique object identifier to it, and begins to add data to the object as needed. This might occur, for example, when a member defines a new event, wherein the website 100 would generate a new instance of an event in the event store 315, assign a unique identifier to the event, and begin to populate the fields of the event with information provided by the member.

### Providing Advertisements to Members

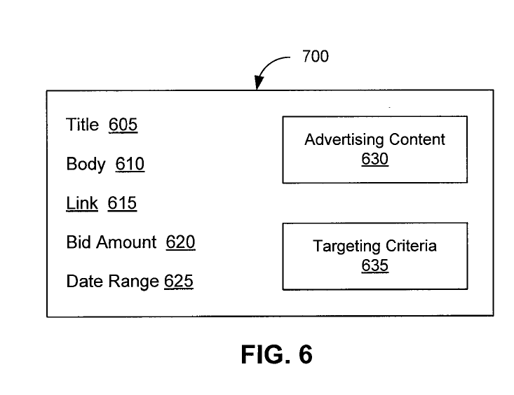

FIG. 4 illustrates a process for selecting an ad, which may be performed by the ad server 380. The ad server 380 receives 405 a request for an ad (“an ad request”) for a particular member. The ad request describes one or more ads from an advertiser for presentation to a particular member. In one embodiment, this request specifies the particular member by including the member's unique member identifier with the request. The ad server 380 then applies 410 targeting criteria, if any, for each of the ad requests in the ad request database 175 to the member. As described in more detail below in connection with FIG. 6, an ad request may specify a set of targeting criteria to direct the ads to only those members who fit certain criteria. An example targeting criteria may specify any members between the ages of 18 and 30 and who have music in their interests. In an embodiment, the targeting criteria describe various user demographics, such as gender, age, educational history, geographic area, employment type or other data from the member profile.

The targeting criteria may also describe an association between a member and actions by a member occurring on and/or off the social networking website 100, allowing the targeting criteria to account for more than the member's profile. Examples of actions included in the targeing criteria include sending a message to another member, using a third-party application, joining a group, leaving a group, generating an event description, purchasing or reviewing a product or service using an online marketplace, requesting information from a third-party website or other modification or retrieval of data stored by the social networking website 100 or a third-party website 140. This allows the target criteria to specify one or more actions that when performed by a member identify the member as a potential target for an ad. For example, the targeting criteria may identify members who have recently accessed content describing a particular brand or model of car. Hence, the targeting criteria may also account for actions performed by a member, allowing additional information about member activity and/or interests to be used for selecting ads relevant to the member. The ad server 380 would thus apply these targeting criteria to a particular member and stored actions associated with the particular member to determine whether to use or ignore this ad request for the member. This would then be repeated for each ad request, using the corresponding targeting criteria contained in each ad request. Ad requests having targeting criteria matching a member profile and logged actions associated with a member are identified as candidate ads, which are ads that are potentially relevant to those members whose profiles match the targeting criteria.

In one embodiment, to select which one or ones of the candidate ads to generate, the ad server 380 computes 420 an expected value for each of the candidate ads. In one embodiment, the expected value is computed as a function of a per-click bid price for the ad weighted by an estimated probability that the ad will be clicked by the potential recipient. To estimate the probability that a particular member will click on an ad, the ad server 380 may compute this probability as a weighted function of the member's affinities for the targeting criteria associated with the candidate ad. Additionally, computation 420 of the expected value for each of the candidate ads may include data about the advertiser requesting the ad. For example, the number of members targeted by the advertiser may affect the bid price, allowing candidate ads from an advertiser having a lower bid amount but a larger group of potentially accessible members to have a higher expected value than candidate ads from an advertiser having a higher bid amount but a smaller group of potentially accessible members. Alternatively, the expected value is weighted by the amount of common data in the targeting criteria and a member's profile, so that ads more likely to be accessed by the user and provide revenue to the social networking website 100 have a higher expected value. For example, if the targeting criteria include 8 elements and a member profile matches 4 elements of the targeting criteria the expected value is weighted by the ratio of the number of target criteria elements matching the member profile to the number of target criteria, or 0.5 in this example. In other embodimetns, different functions of the targeting criteria and member profile are used to weight the expected value.

Once the expected values are computed for the candidate ads, the ad server 380 selects 430 an ad or ads for the candidate with the highest expected value. In an embodiment, the ad server 380 retrieves a locally stored banner ad, or receives a banner ad from a third-party website 140, to compose 430 the ad. The composed ad or ads are thus the ad or ads that will bring the most revenue value to the social networking website 100 because of the probability that the composed ad will be selected and the bid amount that will be paid to the website 100 if it is selected. If more than one ad is desired, the ad server 380 may compose 430 an ad or ads for the desired number of candidate ads having the highest expected values. In an embodiment, the ad server 380 may compose 430 multiple ads that are subsequently presented to the member, allowing the social network website 100 to provide data from multiple advertisers to a member.

### Advertising Model

FIG. 5 illustrates an event diagram for an advertising model in accordance with one embodiment of the invention. In this advertising model, a number of advertisers 520 bid for the placement of ads on a social networking website 100. A social networking website operator 510 receives these bids, for example, through a web interface accessible to the advertisers 520. Accompanying each bid is a description of the ad that the advertiser 520 would like to publish to selected web pages on the social networking website 100. The web interface may thus allow an advertiser 520 to specify all of the relevant information for an ad request, including the bid amount for the ad. In one embodiment, the advertisers 520 specify ad requests, such as the one shown in FIG. 6.

FIG. 6 is a diagram of some of the components of an ad request 600, which an advertiser 520 provides the social networking website operator 510. The ad request 600 may be stored by the social networking website 100 in the ad request database 175. In the example embodiment shown, the ad request 600 comprises a title field 605, a body field 610, a hyperlink field 615, and a bid amount field 620 and a date range field 625. In an embodiment, the ad request 600 also includes a budget field, allowing the advertiser to specify a budget per time frame the advertiser wants to bid, allowing the advertiser to place a limit on the amount spend for ads each day, each week or during a time interval specified by the date range field 625.

The title field 605 and body field 610 may be used by the website to publish information describing the advertiser. For example, the ad may include the title field 605 as the header and then textual data describing the ad. For example, the body field 610 may specify: “Tickets for [Event.Name] are available from [Advertiser].” The resulting ad would include this text. Alternatively, the body field 610 may identify an image associated with an advertiser or advertiser's product or service, causing the resulting ad to display the identified image on the website. The hyperlink field 615 includes a hyperlink to a website or other online service, such as a website associated with the advertiser, and may also be added to the content of the ad, for example, for providing the call to action of the ad. Lastly, the ad request 600 may contain additional advertising content 630 to be appended to the ad. This content 630 may include any type of media content suitable for presentation on a web page, including images, video, audio, hyperlinks, email addresses or any other suitable content.

The bid amount field 620 specified in the ad request 600 may indicate an amount of money that the advertiser 520 will pay for each time a member presented with the ad clicks on it. Alternatively, the bid amount field 620 may specify an amount that the advertiser 520 will pay the website operator 510 each time the ad is displayed to a member or a certain number of members. The date range field 625 specifies a time range in which the ad is to be displayed, allowing the advertiser to present different advertisements at different times. For example, an advertiser may submit multiple ad requests having different date range fields 625, allowing the advertiser to present different ads at different times throughout a day, month or other time interval. This allows the advertiser to show different advertising content 630 at different times, allowing an advertiser to present a variety of ads, or promotion, to further improve the likelihood of a member accessing an ad associated with the advertiser. In addition, the ad request 600 may allow the advertiser 520 to specify targeting criteria 635, the use of which is described above in connection with step 410 of the process for generating an ad.

These targeting criteria may be a filter to apply to fields of a member profile and/or action log entries associated with a member or other object, and/or may include free form text. Data included in one or more member profiles is compared to the targeting criteria and member profiles including the targeting criteria are selected. Action log entries associated with members is also compared to the targeting criteria and members who have performed actions described by the targeting criteria are selected. Hence, the targeting criteria allows advertisers to identify groups of members that are most likely to purchase a good or service from the advertiser or are likely to be interested in goods or services provided by the advertiser. In an embodiment, the targeting criteria are used by the ad server 380 to generate groups of users matching specific targeting criteria, simplifying subsequent distribution of ads. Thus, the targeting criteria allows advertisers to provide ads that are focused to specific members, increasing the likelihood that members viewing the ads will purchase goods or services from the advertiser.

In one embodiment, the targeting criteria may specify actions between a member and another member of the social network, an item of content, or any other object in the social networking environment. The targeting criteria may also specify interactions between a member and objects that are performed on the Internet in other domains (e.g., on a third party website 140) and/or actions taken in the real world (e.g., as recorded by an action terminal 150). In one example, the targeting criteria may specify members who have added a particular event to their calendar. As another example, the ad server 380 accesses the action log 160 to determine whether a member has taken an action identified in the targeting criteria, such as sending a message to another member, using a third-party application, joining a group, leaving a group, generating an event description, purchasing or reviewing a product or service using an online marketplace, requesting information from a third-party website or other modification or retrieval of data stored by the social networking website 100 or a third-party website 140. Including actions in the targeting criteria allows advertisers to further refine the members who are candidates to receive ads by using more information about members. The resulting ad would then be very precisely targeted. For example, a candidate ad would be presented to only those users who are planning to attend an event described in the targeting criteria of the ad request. Hence, the targeting criteria may also identify types of actions in addition to the content of a member profile to be used in identifying ads for presentation to a member, further increasing the likelihood that a member views ads targeted to the member's interests and/or characteristics.

### SUMMARY

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, a client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for advertising to members of a social network, the method comprising:
maintaining a profile for a plurality of members of the social network, each profile identifying one or more characteristics associated with a member and one or more connections to other members of the social network;
logging actions taken by members of the social network, each logged action including information about the action;
receiving a plurality of advertisement requests to advertise to members of the social network, each advertisement request comprising an advertisement and targeting criteria that identify one or more actions that can be taken by a member; and
for one of the members of the social network:
selecting an advertisement for the member, wherein the targeting criteria of the advertisement request associated with the selected advertisement matches one or more logged actions taken by the member, and
presenting the selected advertisement to the user.

2. The method of claim 1, wherein the social network comprises a social networking website.

3. The method of claim 2, wherein the selected advertisement is presented to the member in response to a request from the user for a web page.

4. The method of claim 1, wherein the logged actions comprise an action taken within the social network.

5. The method of claim 1, wherein the logged actions comprise an action taken on a third-party website and communicated to the social network.

6. The method of claim 1, wherein the logged actions comprise a transaction observed by an action terminal and communicated to the social network.

7. The method of claim 1, wherein the actions taken by a member in the social network comprise an action selected from a group consisting of: sending a message to another member of the social network, and adding a connection to another member of the social network.

8. The method of claim 1, wherein the actions taken by a member in the social network comprise using an application in the social network.

9. The method of claim 1, wherein the actions taken by a member in the social network comprise joining a group in the social network.

10. The method of claim 1, wherein the actions taken by a member in the social network comprise adding an event to a member's calendar.

11. The method of claim 1, wherein the actions taken by a member in the social network comprise an action selected from a group consisting of: purchasing a product or service, selling a product or service, reviewing a product or service, and using an online marketplace.

12. The method of claim 1, wherein the targeting criteria further comprise demographic data.

13. The method of claim 1, wherein each advertisement request comprises a bid amount associated with a member's interaction with the advertisement of the advertisement request.

14. The method of claim 13, wherein selecting the advertisement for the user further comprises:
determining a plurality of candidate advertisements for the member, wherein the targeting criteria of the advertisement request associated with each of the candidate advertisements matches one or more logged actions taken by the member;
calculating an expected revenue for each of the candidate advertisements based on the bid amount associated with the advertisement and a likelihood that the member with interact with the advertisement; and
selecting the candidate advertisement having the highest expected revenue value.

15. A system for advertising to members of a social network, the system comprising:
a user profile for maintaining a profile for a plurality of members of the social network, each profile identifying one or more characteristics associated with a member and one or more connections to other members of the social network;
an action log for logging actions taken by members of the social network, each logged action including information about the action;
an advertising server for receiving a plurality of advertisement requests to advertise to members of the social network, each advertisement request comprising an advertisement and targeting criteria that identify one or more actions that can be taken by a member; and
for one of the members of the social network:
selecting an advertisement for the member, wherein the targeting criteria of the advertisement request associated with the selected advertisement matches one or more logged actions taken by the member, and
presenting the selected advertisement to the user.

16. The system of claim 15, wherein the social network comprises a social networking website.

17. The method of claim 16, wherein the selected advertisement is presented to the member in response to a request from the user for a web page.

18. The system of claim 15, wherein the logged actions comprise an action taken within the social network.

19. The system of claim 15, wherein the logged actions comprise an action taken on a third-party website and communicated to the social network.

20. The system of claim 15, wherein the logged actions comprise a transaction observed by an action terminal and communicated to the social network.

21. The system of claim 15, wherein the actions taken by a member in the social network comprise an action selected from a group consisting of: sending a message to another member of the social network, and adding a connection to another member of the social network.

22. The system of claim 15, wherein the actions taken by a member in the social network comprise using an application in the social network.

23. The system of claim 15, wherein the actions taken by a member in the social network comprise joining a group in the social network.

24. The system of claim 15, wherein the actions taken by a member in the social network comprise adding an event to a member's calendar.

25. The system of claim 15, wherein the actions taken by a member in the social network comprise an action selected from a group consisting of: purchasing a product or service, selling a product or service, reviewing a product or service, and using an online marketplace.

26. The system of claim 15, wherein the targeting criteria further comprise demographic data.

27. The system of claim 15, wherein each advertisement request comprises a bid amount associated with a member's interaction with the advertisement of the advertisement request.

28. The system of claim 27, wherein selecting the advertisement for the user further comprises:
determining a plurality of candidate advertisements for the member, wherein the targeting criteria of the advertisement request associated with each of the candidate advertisements matches one or more logged actions taken by the member;
calculating an expected revenue for each of the candidate advertisements based on the bid amount associated with the advertisement and a likelihood that the member with interact with the advertisement; and
selecting the candidate advertisement having the highest expected revenue value.

29. A method for selecting an advertisement to present by a social networking website, the method comprising:
receiving multiple advertisements for the social networking website, each advertisement associated with a set of targeting criteria that specify one or more interactions between a user and an object in the social networking website;
selecting one or more candidate advertisements for a user of the social networking website, wherein the users has performed the interactions specified by the targeting criteria of each of the selected candidate advertisements;
computing an affinity score between the user and each of the candidate advertisements;
receiving a bid amount associated with the advertisements;
selecting one or more of the candidate advertisements based on the affinity scores and the bid amounts associated with the candidate advertisements; and
presenting the selected advertisements on a web page delivered to the user.

30. The method of claim 29, wherein the bid amount for one or more of the advertisements represents an amount of compensation to be received by the website if the user takes a further action with respect to the advertisement.

31. The method of claim 30, wherein the further action comprises a user selection of a link on the advertisement.

32. The method of claim 29, wherein one or more of the advertisements communicate an action taken on the website by another user with whom the user has a connection

33. The method of claim 29, wherein selecting one or more of the advertisements based on the advertisements' affinity scores and bid amounts comprises:
calculating an expected value for each of the advertisements using the bid amount associated with each advertisement and a probability that the user will access the advertisement; and
selecting an advertisement having the maximum expected value.
